(19) United States
(12) Patent Application Publication
(10) Pub. No.: US 2009/0169922 A1
(43) Pub. Date: Jul. 2, 2009

(54) MAGNETIC DISK MANUFACTURING METHOD AND MAGNETIC DISK

(75) Inventor: Masafumi Ishiyama, Thuas Link (SG)

Correspondence Address: SUGHRUE-265550, 2100 PENNSYLVANIA AVE. NW, WASHINGTON, DC, 20037-3213, US

(73) Assignees: HOYA CORPORATION, Tokyo (JP); HOYA MAGNETICS SINGAPORE PTE. LTD, (SG)

(21) Appl. No.: 12/294,285

(22) PCT Filed: Mar. 23, 2007
(86) PCT No.: PCT/JP2007/056004

§ 371 Date: Sep. 24, 2008

(30) Foreign Application Priority Data
Mar. 24, 2006 (JP) 2006-082114

(51) Int. Cl. G11B 5/33; B05D 3/00

(52) U.S. Cl. 428/800; 427/294

(57) ABSTRACT

In a method of manufacturing a magnetic disk including at least a substrate 1, a magnetic layer 3 formed on the substrate 1 in order to carry out magnetic recording, and a protecting layer 4 formed on the magnetic layer 3 in order to protect the magnetic layer 3, the protecting layer 4 has a carbon hydride protecting film 4a substantially formed of carbon and hydrogen on a side of the magnetic layer 3. The method includes a carbon hydride protecting film forming step of forming the carbon hydride protecting film 4a in an atmosphere having a degree of vacuum ranging from 0.1 Pa to 2 Pa while carrying out a plasma ignition using an igniter for maintaining a stable plasma discharge.

### TECHNICAL FIELD

The present invention relates to a method of manufacturing a magnetic disk for use in a magnetic disk device such as a hard disk drive (HDD), and the magnetic disk.

### BACKGROUND ART

Recently, for an information recording technique, particularly, a magnetic recording technique, a rapidly technological innovation has been demanded with the progress of an IT industry. In a magnetic disk loaded onto a magnetic disk device such as a hard disk drive (HDD), there has been required a technique capable of achieving an information recording density of 60 Gbits/inch2 to 100 Gbits/inch2. In the magnetic disk, conventionally, a magnetic layer serving as record information is provided on a substrate and a protecting layer for protecting the magnetic layer and a lubricating layer for buffering an interference from a magnetic head carrying out a floating flight are provided on the magnetic layer.

### Patent Document 1: International Laid-Open No. 99/014746 Brochure

### DISCLOSURE OF THE INVENTION

### Problems to be Solved

Various approaches have been made to achieve an information recording density of 60 Gbits/inch2 or more according to a recent demand for an increase in a recording density. As one of them, a gap (magnetic spacing) between a magnetic layer of a magnetic disk and a recording and reproducing unit of a magnetic head has been demanded to be reduced to 20 nm or less in order to improve a spacing loss and to enhance an S/N ratio.

In respect of an achievement of the magnetic spacing, a thickness of a protecting layer of the magnetic disk has been demanded to be reduced to 3 nm or less.

Moreover, a floating amount of the magnetic head has been demanded to be reduced to 10 nm or less.

Furthermore, a starting and stop mechanism of an HDD has been demanded to have an LUL system (a lamp loading system) capable of a high capacity in place of a conventional CSS system.

In addition, there has been proposed a method of forming a protecting layer by a plasma CVD method in order to ensure an abrasion resistance and a sliding property of a thin film formed on a magnetic disk (see e.g., Patent Document 1).

In a thin film region having a film thickness of less than 3 nm in the protecting layer obtained by the method, however, it is impossible to obtain a sufficient sliding durability (a durable reliability).

In the case where a sliding durability of the protecting layer cannot be obtained sufficiently, there is a problem in that a minute scratch is generated on a magnetic disk due to a shock applied when a magnetic head is loaded onto the magnetic disk, resulting in a reduction in a reproducing signal in a current magnetic disk device having an LUL system, for example.

In the case where a floating height of the magnetic head is set to 10 nm or less, furthermore, there is a problem in that an intermittent contact is generated between the magnetic head and the magnetic disk so that the floating is not stabilized or there is a serious problem in that the recording and reproducing unit of the magnetic head is contaminated and the record and reproduction is thus disabled.

The present invention has been made in consideration of the above problems. It is an object of the present invention to provide a magnetic disk which is suitable for an abrasion resistance and a sliding property even if a protecting layer has a film thickness of 3 nm or less.

Moreover, it is an object of the present invention to provide a magnetic disk which is suitable for an LUL system.

### Means for Solving the Problems

As a method of forming a protecting layer on a magnetic layer, conventionally, there has been known a method of fabricating a carbon hydride protecting film by a CVD method using only a hydrocarbon gas as a reactant gas (a material gas), a method of forming a carbon hydride protecting film using a mixed gas of an inert gas such as Ar and a hydrocarbon gas, or a method of fabricating a protecting layer using a mixed gas of a hydrogen gas and the hydrocarbon gas.

In the above methods, a pressure (a degree of vacuum) of the reactant gas is set to 2 to 6 Pa.

However, the present inventor found a problem in that a film strength is considerably reduced because a durability strength of a very thin protecting layer having a thickness of 3 nm or less is insufficient when the protecting layer is formed by the above methods.

In this case, in a magnetic disk having an LUL system, for example, there is caused a problem in that a minute scratch is generated on a magnetic disk to reduce a reproducing signal due to a shock applied when the magnetic head is loaded onto the magnetic disk.

In order to avoid them, the inventor earnestly made studies.

In order to maintain an excellent sliding durability also even when the protecting layer has a film thickness of 3 nm or less, attention was paid to a degree of vacuum in the formation of the protecting layer.

As a result, it was found that the film strength of the protecting layer can be increased by regulating the degree of vacuum in an atmosphere in forming carbon hydride protecting film.

It was found that the excellent sliding durability can be maintained even when the protecting layer has a film thickness of 3 nm or less by setting the degree of vacuum in the atmosphere (a pressure of a reactant gas) to be a degree of vacuum having a low pressure (i.e., 0.1 to 2 Pa, which will be hereinafter referred to as a low pressure vacuum degree).

In the case where the film is formed by a method using a plasma such as a plasma CVD method, however, there is further caused a problem in that a plasma cannot be formed easily and a stable discharge cannot be carried out because a pressure is very low when the degree of vacuum is 2 Pa or less.

More specifically, the degree of vacuum of 2 Pa or less causes an unstable discharging region. Consequently, there is also a problem in that a plasma cannot be discharged stably and the protecting layer cannot be formed stably.

On the other hand, the present inventor found that a plasma can be easily generated and discharged at a low pressure vacuum degree (0.1 to 2 Pa) with a plasma ignition using an igniter in advance.

Consequently, it is possible to stably form the protecting layer at the low pressure vacuum degree (0.1 to 2 Pa). Based on the findings, the present inventor made the present invention. More specifically, the present invention has the following structures.

(Structure 1) In a method of manufacturing a magnetic disk including at least a substrate, a magnetic layer formed on the substrate in order to carry out magnetic recording, and a protecting layer formed on the magnetic layer in order to protect the magnetic layer, the protecting layer has a carbon hydride protecting film substantially formed of carbon and hydrogen on a side of the magnetic layer. The method includes a carbon hydride protecting film forming step of forming the carbon hydride protecting film in an atmosphere having a degree of vacuum ranging from 0.1 Pa to 2 Pa while carrying out a plasma ignition using an igniter for maintaining a stable plasma discharge.

Even when using a protecting layer having a thickness of 3 nm or less, in which a durability abnormality such as a scratch is generated and a reproducing signal is deteriorated in a conventional manufacturing method, consequently, it is possible to ensure an excellent sliding durability. Therefore, also in use for a magnetic disk having an LUL system, for example, it is possible to obtain a magnetic disk in which durability has no problem.

The reason why the carbon hydride protecting film is formed at a low pressure vacuum degree (0.1 to 2 Pa) is as follows.

When the low pressure vacuum degree (0.1 to 2 Pa) is set, the influence such as a disturbing molecule for disturbing a kinetic energy is lessened much more greatly than that at a high pressure (2 to 6 Pa) vacuum degree (hereinafter referred to as a high pressure vacuum degree) before a carbon atom decomposed by a plasma reaches the substrate.

A reduction in chances for a collision with the disturbing molecule before the arrival of the carbon atom at the substrate implies that the carbon atom can reach the substrate with a high energy.

In this case, a carbon hydride protecting film is formed by the carbon atom with the high energy. Therefore, it is possible to form a protecting layer which is dense and durable.

Thus, it is possible to form a dense film at the low pressure vacuum degree (0.1 to 2 Pa). Even at a degree of vacuum having a lower pressure than 0.1 Pa, it is possible to carry out an ignition using an igniter.

In this case, however, a film forming speed at which the carbon hydride protecting film is formed is extremely reduced, and thus there is a practical problem. For this reason, a pressure in a range of 0.1 Pa to 2 Pa is suitable.

The substrate is non-magnetic, for example.

It is preferable that a glass substrate should be used for the substrate.

The glass substrate is particularly preferable because a smoothness and a high rigidity can be obtained and a magnetic spacing, above all, a floating amount of the magnetic head can be thus reduced more stably.

An aluminosilicate glass is particularly preferable as a material of the glass substrate.

The alminosilicate glass can obtain a high rigidity and strength by chemical strengthening.

It is preferable that a surface roughness of the surface of the magnetic disk should have Rmax of 4 nm or less. If the Rmax exceeds 4 nm, a reduction in the magnetic spacing is inhibited, which is not preferable.

The surface roughness is defined by the Japanese Industrial Standard (JIS) B0601. Moreover, the magnetic disk may further include another layer such as a non-magnetic ground layer.

The ground layer is formed between the substrate and the magnetic layer, for example.

(Structure 2) The magnetic disk further includes a lubricating layer formed on the protecting layer. The protecting layer includes a surface layer portion provided between the carbon hydride protecting film and the lubricating layer and containing carbon and nitrogen and having a higher adhesion to the lubricating layer than the carbon hydride protecting film. The method further includes a surface layer portion forming step of forming the surface layer portion in an atmosphere having a degree of vacuum ranging from 2 Pa to 6 Pa.

Thus, it is possible to enhance an adhesion between the protecting layer and the lubricating layer.

In the surface layer portion forming step, for example, the carbon hydride protecting film is subjected to a surface treatment in an atmosphere containing nitrogen, thereby forming a surface layer portion, for example.

In the surface layer portion forming step, the surface layer portion may be formed through a film forming step such as a plasma CVD method.

Moreover, it is preferable that a substrate on which layers including the surface layer portion are formed should be cleaned with ultrapure water and isopropyl alcohol, for example, after the formation of the protecting layer.

Consequently, it is possible to enhance a surface quality of the magnetic disk.

The reason why the surface layer portion is formed at a high pressure vacuum degree (2 to 6 Pa) is as follows.

The surface layer portion requires a function of maintaining an adhesion to a lubricating layer to be formed thereon. In order to ensure the adhesion to the lubricating layer, therefore, nitrogen is introduced to form the surface layer portion. However, it has been generally known that a nitrogen carbide film has a poor durability in the case where a durability of the carbon hydride film is compared with that of the nitrogen carbide film.

For this reason, the surface layer portion of the nitrogen carbide film is required for ensuring the adhesion to the lubricating layer. If nitrogen is unnecessarily oriented, however, there is a problem in that the durability is deteriorated.

In order to prevent the nitrogen from being oriented unnecessarily with respect to the surface of the carbon hydride protecting film through a reverse thinking manner to the method of forming the carbon hydride protecting film, therefore, the surface layer portion is formed in the atmosphere of a high pressure vacuum degree (2 to 6 Pa). When the surface layer portion is formed at the low pressure vacuum degree, the nitrogen is implanted in a large amount into the carbon hydride protecting film so that the nitrogen present on the surface is increased, resulting in a deterioration in a durability.

As the atmosphere at which the surface layer portion is formed, accordingly, a range of the high pressure vacuum degree (2 to 6 Pa) is suitable.

Thus, the protecting layer is formed by a combination of the formation of the carbon hydride protecting film at the low pressure vacuum degree (0.1 to 2 Pa) and that of the surface layer portion at the high pressure vacuum degree (2 Pa to 6 Pa), thereby having both the durability and the adhesion to the lubricating layer.

Even when the film thickness of the protecting layer is set to 3 nm or less, therefore, it is possible to provide a magnetic disk which is suitable for an abrasion resistance and a sliding property.

It is preferable that the lubricating layer should contain a perfluoropolyether compound having a hydroxyl group in an end group.

The perfluoropolyether has a linear chain structure and can exhibit a proper lubricating performance for the magnetic disk, and has a hydroxyl group (OH) in the end group and can thus exhibit a high adhesion performance to the protecting layer.

With the structure having the surface layer portion containing the nitrogen on the surface of the protecting layer, particularly, (N+) and (OH−) produce a high compatibility. Therefore, it is possible to obtain a high lubricating layer adhesion ratio. Thus, the structure is suitable.

It is preferable that the number of hydroxyl groups provided in one molecule should be two to four for the perfluoropolyether compound having the hydroxyl group in the end group.

The number which is smaller than two is not preferable because the adhesion ratio of the lubricating ratio is reduced in some cases.

If the number exceeds four, moreover, the adhesion ratio is excessively enhanced. As a result, a lubricating performance is deteriorated in some cases. It is preferable that the film thickness of the lubricating layer should be properly regulated in a range of 0.5 nm to 1.5 nm.

In some cases where the film thickness is smaller than 0.5 nm, the lubricating performance is deteriorated. In some cases where the film thickness is greater than 1.5 nm, the adhesion ratio of the lubricating layer is reduced.

(Structure 3) The carbon hydride protecting film forming step includes: forming the carbon hydride protecting film by a plasma CVD method which only a straight-chain saturated hydrocarbon gas is substantially used as a reactant gas without using carrier gas.

When the carbon hydride protecting film is formed by the plasma CVD method, it is preferable to form diamondlike carbon using only a carbon hydride gas as a reactant gas.

In the case where a carrier gas such as another inert gas (e.g., Ar) or a hydrogen gas is mixed with a carbon hydride gas, the impurity gases are introduced into the carbon hydride protecting film so that a film density is reduced, which is not preferable.

Moreover, it is preferable to use lower carbon hydride as the reactant gas.

Above all, it is preferable to use straight-chain lower carbon hydride such as straight-chain lower saturated carbon hydride or straight-chain lower unsaturated carbon hydride.

Methane, ethane, propane, butane or octane may be used as the straight-chain lower saturated carbon hydride. Also, ethylene, propylene, butylene or acetylene may be used as the straight-chain lower unsaturated carbon hydride.

The lower carbon hydride implies carbon hydride having the number of carbons of 1 to 10 per molecule. The straight-chain lower carbon hydride is used because it is hard to vaporize the straight-chain lower carbon hydride as a gas to supply the gas to a film forming apparatus in accordance with increase of the number of carbons, and furthermore, it is hard to carry out a decomposition in a plasma discharge.

When the number of carbons is increased, moreover, a polymer carbon hydride component is contained in a large amount in a component of the formed protecting layer and thus denseness and hardness of the protecting layer are reduced, which is not preferable. In case of cyclic carbon hydride, moreover, it is harder to carry out the decomposition in the plasma discharge than that for the straight-chain carbon hydride, which is not preferable. In this respect, it is particularly preferable to use the straight-chain lower carbon hydride as carbon hydride. Above all, it is particularly preferable to use ethylene because a dense protecting layer having a high hardness can be formed.

It is preferable that the film thickness of the protecting layer to be formed by the plasma CVD method should be 1 nm or less.

If the thickness is smaller than 1 nm, a covering ratio of the protecting layer is reduced. In some cases, therefore, the film thickness is not enough for preventing a migration of a metal ion of the magnetic layer.

Moreover, an abrasion resistance has a problem. It is not particularly necessary to set an upper limit to the film thickness of the protecting layer. However, it is preferable to practically set the film thickness to 3 nm or less so as not to inhibit a magnetic spacing improvement.

It is preferable that the carbon hydride protecting film should be formed in an atmosphere in which a film forming temperature is in a range of room temperature to 250° C. at the carbon hydride protecting film forming step.

As a result of the studies of the present inventor, it was found that a dense carbon hydride protecting film having a high hardness can be formed when a substrate temperature is set in a range of room temperature to 250° C.

This appears to be caused by the fact that a carbon atom reaching the substrate can easily be moved over the substrate when the film forming temperature is raised to be excessively high, and the carbon atom is thus diffused into the surface layer to make a growth on a graphite basis. More specifically, it is preferable that the temperature should be set in a range of the room temperature to 250° C., and furthermore, the carbon hydride protecting film should be formed at a low pressure vacuum degree (0.1 to 2 Pa).

It is further preferable that the substrate should be forcibly cooled immediately before the formation of the carbon hydride protecting film. At this time, it is preferable that the temperature should be 150° C. or less.

Usually, there is provided a step of heating the substrate to maintain a desirable holding force. After the substrate is heated, the temperature is gradually dropped according to the film formation of a ground layer, a seed layer and a magnetic layer in order. In some cases, however, it is not sufficient.

In these cases, it is preferable to cool the substrate just before the carbon hydride protecting film is formed.

More specifically, it is possible to reduce the temperature of the substrate by causing a chamber to have a cooling function just before the formation of the carbon hydride protecting film and introducing an He gas having a great specific heat and a high cooling efficiency.

Moreover, it is preferable to apply a bias of −50V to −300V to the substrate, thereby forming the carbon hydride protecting film at the carbon hydride protecting film forming step.

If the bias is lower than −50V, an advantage of the bias application is not sufficient.

In the case where a voltage exceeding -300V is applied, moreover, an excessive energy is given to the substrate so that arching is generated to cause the generation of a particle or a contamination, which is not preferable.

(Structure 4) An atomic weight ratio (N/C) of nitrogen and carbon is in a range of 0.05 to 0.15 in an uppermost surface of the protecting layer.

It is possible to measure an atomic weight ratio (N/C) of nitrogen/carbon using an X-ray photoelectron spectroscopy (which will be hereinafter referred to as ESCA), for example. It is possible to obtain the atomic weight ratio of nitrogen/carbon from intensities of an Nls spectrum and a Cls spectrum which are measured using the ESCA.

In some cases where N/C is lower than 0.05, the adhesion to the lubricating layer is deteriorated. In some cases where N/C exceeds 0.15, moreover, the hardness of the protecting layer is reduced, which is not preferable.

By setting N/C into a range of 0.05 to 0.15, accordingly, it is possible to cause the adhesion and hardness of the protecting layer and the lubricating layer, which are formed by the CVD, to be particularly suitable, for example.

(Structure 5) The magnetic disk is used for an HDD having an LUL system.

With the same advantage as that of the structure 1, thus, it is possible to obtain a magnetic disk in which a durability has no problem also in use for the magnetic disk having the LUL system.

(Structure 6) A magnetic disk includes at least a substrate, a magnetic layer formed on the substrate in order to carry out magnetic recording, and a protecting layer formed on the magnetic layer in order to protect the magnetic layer. The protecting layer has a carbon hydride protecting film substantially formed of carbon and hydrogen on a side of the magnetic layer. An atomic weight ratio (N/C) of nitrogen and carbon is in a range of 0.05 to 0.15 in an uppermost surface of the protecting layer. With this structure, it is possible to obtain the same advantage as that of the structure 4.

### ADVANTAGE OF THE INVENTION

According to the present invention, it is possible to provide a magnetic disk which is suitable for an abrasion resistance and a sliding property even if a protecting layer has a film thickness of 3 nm or less.

According to the present invention, moreover, it is possible to provide a magnetic disk suitable for an LUL system.

### BRIEF DESCRIPTION OF THE DRAWINGS

FIG. 1 is a sectional view showing a layer structure of a magnetic disk 10 according to an embodiment of the present invention.

### DESCRIPTION OF THE DESIGNATIONS

1 . . . substrate, 10 . . . magnetic disk, 2 . . . nonmagnetic metal layer, 2a . . . first ground layer, 2b . . . second ground layer, 3 . . . magnetic layer, 4 . . . protecting layer, 4a . . . carbon hydride protecting film, 4b . . . surface layer portion, 5 . . . lubricating layer

### BEST MODE FOR CARRYING OUT THE INVENTION

An embodiment of the present invention will be described below with reference to the drawings.

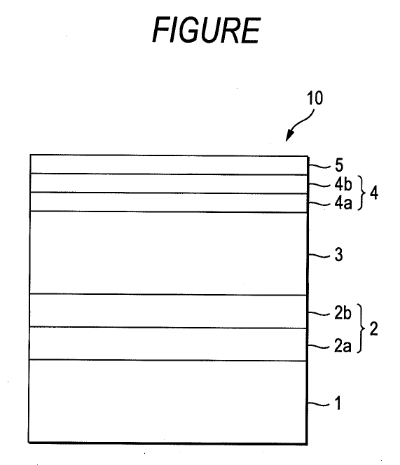

FIG. 1 is a sectional view showing a layer structure of a magnetic disk 10 according to the embodiment of the present invention.

The magnetic disk 10 comprises at least a substrate 1, a magnetic layer 3 formed on the substrate 1, a protecting layer 4 formed on the magnetic layer 3, and a lubricating layer 5 formed on the protecting layer 4.

In the embodiment, the magnetic disk 10 further comprises a nonmagnetic metal layer 2 having a first ground layer 2a and a second ground layer 2b between the substrate 1 and the magnetic layer 3.

Moreover, the magnetic layer 3 and the protecting layer 4, and the protecting layer 4 and the lubricating layer 5 are formed to be in contact with each other. In the magnetic disk 10, all of layers other than the magnetic layer 3 are non-magnetic substances.

The protecting layer 4 has a carbon hydride protecting film 4a and a surface layer portion 4b. The carbon hydride protecting film 4a is substantially formed of carbon and hydrogen.

The carbon hydride protecting film 4a is in contact with the magnetic layer 3 and is formed by plasma CVD on the magnetic layer 3 side. The surface layer portion 4b is a surface-treated layer containing carbon and nitrogen, and is formed in contact with the carbon hydride protecting film 4a.

The surface layer portion 4b may be substantially formed of carbon and nitrogen.

The magnetic disk 10 will be described more specifically according to examples and comparative examples.

However, the present invention is not limited thereto.

Table 1 shows manufacturing conditions and test results in the examples and the comparative examples, which will be described below.

TABLE 1

| | | Carbon | Surface | | | | | | | |
|---|---|---|---|---|---|---|---|---|---|---|
| | | hydride | layer | | | | | | | |
| | | protecting | portion | | | | Film thick- | Atomic weight | | LUL dura- |
| | | film Degree | Degree of | Substrate | | | ness of | ratio of | | bility test |
| | | of vacuum | vacuum | temperature | Bias | Surface | protecting | nitrogen/carbon | | Number of |
| | Igniter | (Pa) | (Pa) | (° C.) | (V) | treatment | layer (nm) | (N/C) | Pin-On | durabilities |
| Example 1 | Yes | 1 | 3 | 250 | −300 | Yes | 3.0 | 0.140 | 500 | 1000000 times or |
| | | | | | | | | | | more |
| Example 2 | Yes | 1 | 2 | 250 | −300 | Yes | 3.0 | 0.145 | 450 | 1000000 times or |
| | | | | | | | | | | more |
| Example 3 | Yes | 1 | 6 | 250 | −300 | Yes | 3.0 | 0.075 | 640 | 1000000 times or |
| | | | | | | | | | | more |
| Example 4 | Yes | 2 | 3 | 250 | −300 | Yes | 3.0 | 0.148 | 480 | 1000000 times or |
| | | | | | | | | | | more |
| Example 5 | Yes | 0.1 | 3 | 250 | −300 | Yes | 3.0 | 0.051 | 740 | 1000000 times or |
| | | | | | | | | | | more |
| Comparative | Yes | 3 | 3 | 250 | −300 | Yes | 3.0 | 0.152 | 250 | Failure at 800000 |
| Example 1 | | | | | | | | | | times |
| Comparative | Yes | 0.05 | 3 | 250 | −300 | Yes | Film cannot be | — | — | — |
| Example 2 | | | | | | | formed | | | |
| | | | | | | | Film forming speed | | | |
| | | | | | | | 0.1 nm/s | | | |
| Comparative | Yes | 1 | 1 | 250 | −300 | Yes | 3.0 | 0.175 | 55 | Failure at 200000 |
| Example 3 | | | | | | | | | | times |
| Comparative | Yes | 1 | 7 | 250 | −300 | Yes | 3.0 | 0.049 | 750 | Failure at 300000 |
| Example 4 | | | | | | | | | | times |
| Comparative | Yes | 1 | 3 | 260 | −300 | Yes | 3.0 | 0.154 | 240 | Failure at 750000 |
| Example 5 | | | | | | | | | | times |
| Example 6 | Yes | 1 | 3 | 25 | −300 | Yes | 3.0 | 0.135 | 575 | 100000 times or |
| | | | | | | | | | | more |
| Comparative | Yes | 1 | 3 | 250 | −40 | Yes | 3.0 | 0.162 | 185 | Failure at 550000 |
| Example 6 | | | | | | | | | | times |
| Comparative | Yes | 1 | 3 | 250 | −310 | Yes | Arching is | — | — | — |
| Example 7 | | | | | | | generated. | | | |
| | | | | | | | Substrate is broken. | | | |
| Comparative | No | 1 | 3 | 250 | −300 | Yes | No discharge | — | — | — |
| Example 8 | | | | | | | | | | |
| Example 7 | Yes | 1 | — | 250 | −300 | No | 3.0 | 0.000 | 980 | — |

### Example 1

Description will be given to a magnetic disk and a method of manufacturing the same according to an example 1.

First of all, a glass substrate and a material of each layer will be described in detail.

The glass substrate is an amorphous glass substrate and a composition is aluminosilicate. A texture for giving a magnetic layer a magnetic anisotropy, in which a magnetic property is excellent in a circumferential direction of a disk, is formed on a surface of the glass substrate.

The texture has an almost regularly linear stripe groove in the circumferential direction of the disk. A glass substrate for a magnetic disk of a 2.5 inch type is used which has a diameter of 65 mm, an inside diameter of 20 mm and a disk thickness of 0.635 mm.

A surface roughness of the formed glass substrate was observed through an atomic force microscope (AMF). As a result, it was confirmed that the glass substrate has a smooth surface, wherein Rmax is 3.48 nm and Ra is 0.35 nm.

Next, a first ground layer 2a, a second ground layer 2b and a magnetic layer 3 were sequentially formed on a substrate 1 through a DC magnetron sputtering method using the C3040 sputtering film forming apparatus manufactured by CANON ANELVA CORPORATION.

More specifically, a CrTi (Cr: 55 at %, Ti: 45 at %) was first used as a sputtering target, and the first ground layer 2a formed by the CrTi alloy having a thickness of 20 nm was formed on the glass substrate 1 by sputtering.

A degree of vacuum in a film formation was 0.6 Pa.

Subsequently, a CoW (Co: 45 at %, W: 55 at %) was used as the sputtering target, and the second ground layer 2b formed by the CrMo alloy having a thickness of 7 nm was formed on the first ground layer 2a by the sputtering.

The degree of vacuum in the film formation was 0.6 Pa. Next, a sputtering target formed by a CoCrPtB (Cr: 20 at %, Pt: 12 at %, B: 5 at %, a residual component is Co) alloy was used as the sputtering target, and the magnetic layer 3 formed by the CoCrPtB alloy having a thickness of 15 nm was formed on the second ground layer 2b by the sputtering.

The degree of vacuum in the film formation was 0.6 Pa.

Moreover, the substrate was heated using a heater heating method before a non-magnetic metal layer 2 (the first ground layer 2a and the second ground layer 2b) are formed such that a temperature of the substrate is 250° C. in forming a protecting layer.

The temperature of the substrate was checked using a radiation thermometer through a window of a chamber just before a protecting layer 4 is formed.

Next, 250 sccm of an ethylene gas was introduced onto a disk having the magnetic layer 3 formed thereon and a plasma ignition was carried out using an igniter at a pressure while a degree of vacuum was set to 1 Pa. Then, a carbon hydride protecting film 4a was formed by a plasma CVD method with bias application of −300V. In the formation of the carbon hydride protecting film 4a, a film forming speed was 1 nm/s.

The igniter will be described in detail.

In order to easily carry out a plasma discharge at a low pressure, the igniter was disposed in the chamber. The igniter is of such a type as to feed an ignition signal controlled at an optimum ignition time to the igniter and to ignite a spark plug.

The igniter turns ON/OFF a power transistor in synchronization with the ignition signal. When the power transistor is turned OFF, a high voltage is generated on an ignition coil so that the spark plug is ignited.

After the carbon hydride protecting film 4a was formed, furthermore, only a nitrogen gas was introduced in an amount of 200 sccm into a plasma to regulate a degree of vacuum to be 3 Pa.

Then, the carbon hydride protecting film 4a was exposed to a nitrogen atmosphere at the pressure and a surface treatment was carried out to form the surface layer portion 4b. After the surface layer portion 4b was formed, an actual film thickness of the protecting layer 4 was measured by a sectional observation through a transmission electron microscope (TEM).

A film thickness of the protecting layer 4 was 3.0 nm.

After the protecting layer 4 was formed, moreover, an atomic weight ratio (N/C) of nitrogen/carbon of the protecting layer 4 was measured through ESCA.

The atomic weight ratio (N/C) was 0.140. A measuring condition of an ESCA analysis was as follows.

Apparatus: Quantum 2000 manufactured by ULVAC-PHI, INC.

X-ray exciting source: Al—Kα ray (1486.6 eV)

X-ray source: 20 W

Degree of vacuum in analyzing chamber: <2×10⁻⁷ Pa

Pass energy: 117.5 eV

Photoelectron detecting angle: 45°

Measuring target peak: Cls, Nls

Analyzing region: 100 μmφ

Number of times of integration: 10 times

Next, the protecting layer 4 was formed and then immersed and cleaned in pure water at 70° C. for 400 seconds, and furthermore, was cleaned for 400 seconds through IPA, and was dried with an IPA vapor for finish drying. Subsequently, a lubricating layer 5 formed of a PFPE (perfluoropolyether) compound was formed, by using a dipping method, on the protecting layer 4 subjected to ultrapure water and IPA cleaning.

More specifically, there was used the alcohol denatured FOMBLIN Z derivative produced by Ausimont Co., Ltd. The compound has one to two hydroxyl groups on each end of a main chain of PFPE, that is, two to four hydroxyl groups per molecule in an end group.

The lubricating layer 5 has a film thickness of 1.4 nm. As described above, the magnetic disk 10 was manufactured.

A surface roughness of the obtained magnetic disk 10 was observed through the AFM. As a result, it was confirmed that the magnetic disk 10 has a smooth surface, wherein Rmax is 3.1 nm and Ra is 0.30 nm.

Moreover, a glide height was measured to be 3.6 nm. In the case where a floating amount of the magnetic head is stably set to 10 nm or less, it is desirable that the glide height of the magnetic disk should be set to 4.5 nm or less.

Various performances of the obtained magnetic disk 10 were evaluated and analyzed in the following manner.

(1) LUL Durability Test

An LUL durability test was carried out using a 2.5 inch type HDD, which is rotated at 5400 rpm, and a magnetic head having a floating amount of 10 nm.

An NPAB (negative pressure type) slider was used as a slider of the magnetic head and a TMR type unit was used as a reproducing unit.

The magnetic disk 10 is loaded onto the HDD and an LUL operation is continuously executed by means of the magnetic head. The number of the LUL times at which the HDD was endured without a failure was measured to evaluate an LUL durability. Moreover, the test was carried out in an environment of 70 C/80% RH.

The condition is severer than a normal HDD operating environment. The test is carried out in an environment in which the HDD to be used for a car navigation is assumed in order to decide a durable reliability of the magnetic disk more properly.

In the magnetic disk 10 according to the example, the LUL times could exceed 1000000 times without a failure.

In the LUL durability test, usually, it is required that the LUL times continuously exceed 400000 times without a failure. In a usual environment in which the HDD is used, it is said that the use for about 10 years is required for the LUL times to exceed 400000 times.

In the LUL durability test, the case where the LUL times exceed 1000000 times was set to non-defective.

(2) Pin-on-Disk Test

A pin-on-disk test was carried out in the following manner.

More specifically, in order to evaluate a durability and an abrasion resistance of the protecting layer 4, the magnetic disk 10 is rotated while a ball formed of Al2O3-TiC and having a diameter of 2 mm is pushed against the protecting layer 4 in a position in a radius of 22 mm in the disk 10 at a load of 15 g.

Consequently, the Al2O3-TiC ball and the protecting layer 4 were relatively rotated and slid at a speed of 2 m/sec to measure the number of the sliding operations before the breakaway of the protecting layer 4 through the sliding operation.

In the pin-on-disk test, if a value (that is, the number of the sliding operations/nm) obtained by normalizing the number of the sliding operations before the breakaway of the protecting layer 4 with the film thickness of the protecting layer 4 is 300 times /nm or more, the magnetic disk 10 is non-defective.

Usually, the magnetic head does not come in contact with the magnetic disk 10. Therefore, the pin-on-disk test is a durability test in a severer environment than an actual use environment. In the magnetic disk 10, the number of the sliding operations /nm was 500 times/nm.

### Example 2

Next, a magnetic disk according to an example 2 was manufactured.

In the magnetic disk according to the example 1, when the protecting layer 4 was formed, an ethylene gas was introduced in an amount of 250 sccm and a plasma ignition was carried out using an igniter at a pressure having a degree of vacuum of 1 Pa, and a carbon hydride protecting film 4a was formed by a plasma CVD method with a bias application of −300V. After the carbon hydride protecting film 4a was formed, furthermore, only a nitrogen gas was introduced in an amount of 200 sccm into a plasma and the carbon hydride protecting film 4a was exposed to a nitrogen atmosphere at a pressure regulated at a degree of vacuum of 2 Pa, and a surface treatment was carried out to form a surface layer portion 4b.

Except for the above aspects, the magnetic disk is the same as that obtained by the same manufacturing method as that in the example 1.

The evaluation and analysis was carried out over the obtained magnetic disk according to the example in the same manner as in the example 1. The result is shown in the Table 1.

### Example 3

Next, a magnetic disk according to an example 3 was manufactured.

In the magnetic disk according to the example 1, when the protecting layer 4 was formed, an ethylene gas was introduced in an amount of 250 sccm and a plasma ignition was carried out using an igniter at a pressure having a degree of vacuum of 1 Pa, and a carbon hydride protecting film 4a was formed by a plasma CVD method with a bias application of −300V. After the carbon hydride protecting film 4a was formed, furthermore, only a nitrogen gas was introduced in an amount of 200 sccm into a plasma and the carbon hydride protecting film 4a was exposed to a nitrogen atmosphere at a pressure regulated at a degree of vacuum of 6 Pa, and a surface treatment was carried out to form a surface layer portion 4b.

Except for the above respects, the magnetic disk is the same as that obtained by the same manufacturing method as that in the example 1.

The evaluation and analysis was carried out over the obtained magnetic disk according to the example in the same manner as in the example 1. The result is shown in the Table 1.

### Example 4

Next, a magnetic disk according to an example 4 was manufactured.

In the magnetic disk according to the example 1, when the protecting layer 4 was formed, an ethylene gas was introduced in an amount of 250 sccm and a plasma ignition was carried out using an igniter at a pressure having a degree of vacuum of 2 Pa, and a carbon hydride protecting film 4a was formed by a plasma CVD method with a bias application of −300V. After the carbon hydride protecting film 4a was formed, furthermore, only a nitrogen gas was introduced in an amount of 200 sccm into a plasma and the carbon hydride protecting film 4a was exposed to a nitrogen atmosphere at a pressure regulated at a degree of vacuum of 3 Pa, and a surface treatment was carried out to form a surface layer portion 4b.

Except for the above aspects, the magnetic disk is the same as that obtained by the same manufacturing method as that in the example 1.

The evaluation and analysis was carried out over the obtained magnetic disk according to the example in the same manner as in the example 1. The result is shown in the Table 1.

### Example 5

Next, a magnetic disk according to an example 5 was manufactured.

In the magnetic disk according to the example 1, when the protecting layer 4 was formed, an ethylene gas was introduced in an amount of 250 sccm and a plasma ignition was carried out using an igniter at a pressure having a degree of vacuum of 0.1 Pa, and a carbon hydride protecting film 4a was formed by a plasma CVD method with a bias application of −300V.

After the carbon hydride protecting film 4a was formed, furthermore, only a nitrogen gas was introduced in an amount of 200 sccm into a plasma and the carbon hydride protecting film 4a was exposed to a nitrogen atmosphere at a pressure regulated at a degree of vacuum of 3 Pa, and a surface treatment was carried out to form a surface layer portion 4b.

Except for the above aspects, the magnetic disk is the same as that obtained by the same manufacturing method as that in the example 1.

The evaluation and analysis was carried out over the obtained magnetic disk according to the example in the same manner as in the example 1. The result is shown in the Table 1.

### Comparative Example 1

Next, a magnetic disk according to a comparative example 1 was manufactured.

In the magnetic disk according to the example 1, when the protecting layer 4 was formed, an ethylene gas was introduced in an amount of 250 sccm and a plasma ignition was carried out using an igniter at a pressure having a degree of vacuum of 3 Pa, and a carbon hydride protecting film 4a was formed by a plasma CVD method with a bias application of −300V. A step of forming the protecting layer 4 is the same as that in the example 1 except for the carbon hydride protecting film 4a.

Except for the above aspects, the magnetic disk is the same as that obtained by the same manufacturing method as that in the example 1.

The evaluation and analysis was carried out over the obtained magnetic disk according to the comparative example in the same manner as in the example 1. The result is shown in the Table 1.

It can be supposed that a hardness of the carbon hydride protecting film 4a was smaller than that in the example 1, and nitrogen in the surface layer portion 4b was thus implanted in a large amount by the carbon hydride protecting film 4a, resulting in a slight increase.

For this reason, the hardness of the whole protecting layer 4 was not sufficient and both a sliding property of a pin-on-disk and an LUL test failed.

### Comparative Example 2

Next, a magnetic disk according to a comparative example 2 was manufactured.

In the magnetic disk according to the example 1, when the protecting layer 4 was formed, an ethylene gas was introduced in an amount of 250 sccm and a plasma ignition was carried out using an igniter at a pressure having a degree of vacuum of 0.05 Pa, and a carbon hydride protecting film 4a was tried to be formed by a plasma CVD method with a bias application of −300V.

Except for the above aspects, the magnetic disk is the same as that obtained by the same manufacturing method as that in the example 1.

Although the plasma ignition was carried out in the comparative example, however, a film forming speed was considerably reduced to be 0.1 nm/s. Therefore, a desirable film thickness of 3 nm could not be obtained.

### Comparative Example 3

Next, a magnetic disk according to a comparative example 3 was manufactured.

In the magnetic disk according to the example 1, when the protecting layer 4 was formed, an ethylene gas was introduced in an amount of 250 sccm and a plasma ignition was carried out using an igniter at a pressure having a degree of vacuum of 1 Pa, and a carbon hydride protecting film 4a was formed by a plasma CVD method with a bias application of −300 V. After the carbon hydride protecting film 4a was formed, furthermore, only a nitrogen gas was introduced in an amount of 200 sccm into a plasma and the carbon hydride protecting film 4a was exposed to a nitrogen atmosphere at a pressure regulated at a degree of vacuum of 1 Pa, and a surface treatment was carried out to form a surface layer portion 4b.

A step of forming the protecting layer 4 is the same as that in the example 1 except for the step of forming the surface layer portion 4b.

Except for the above aspects, the magnetic disk is the same as that obtained by the same manufacturing method as that in the example 1. The evaluation and analysis was carried out over the obtained magnetic disk according to the comparative example in the same manner as in the example 1. The result is shown in the Table 1.

An atomic weight ratio (N/C) of nitrogen/carbon was considerably high, that is, 0.175 and a hardness of the whole protecting layer 4 was not sufficient. Therefore, both a sliding property of a pin-on-disk and an LUL test failed.

### Comparative Example 4

Next, a magnetic disk according to a comparative example 4 was manufactured.

In the magnetic disk according to the example 1, when the protecting layer 4 was formed, an ethylene gas was introduced in an amount of 250 sccm and a plasma ignition was carried out using an igniter at a pressure having a degree of vacuum of 1 Pa, and a carbon hydride protecting film 4a was formed by a plasma CVD method with a bias application of −300 V. After the carbon hydride protecting film 4a was formed, furthermore, only a nitrogen gas was introduced in an amount of 200 sccm into a plasma and the carbon hydride protecting film 4a was exposed to a nitrogen atmosphere at a pressure regulated at a degree of vacuum of 7 Pa, and a surface treatment was carried out to form a surface layer portion 4b.

A step of forming the protecting layer 4 is the same as that in the example 1 except for the step of forming the surface layer portion 4b.

Except for the above aspects, the magnetic disk is the same as that obtained by the same manufacturing method as that in the example 1. The evaluation and analysis was carried out over the obtained magnetic disk according to the comparative example in the same manner as in the example 1. The result is shown in the Table 1.

In a pin-on-disk test, a more excellent value than that in the example 1, that is, a value of 750 was obtained.

An atomic weight ratio (N/C) of nitrogen/carbon of the surface layer portion 4b was considerably low, that is, 0.049, from which it is apparent that the nitrogen is rarely present on a surface. Therefore, it can be supposed that a hardness of the protecting layer 4 was increased and a sliding property of a pin-on-disk was enhanced more greatly than that in the example 1. However, an amount of the nitrogen present on the surface was extremely small. For this reason, a magnetic head generated an adsorbing phenomenon (fly stiction) in an LUL test and caused a failure at 300000 times.

### Comparative Example 5

Next, a magnetic disk according to a comparative example 5 was manufactured.

In the magnetic disk according to the example 1, when the protecting layer 4 was formed, an ethylene gas was introduced in an amount of 250 sccm and a plasma ignition was carried out using an igniter at a pressure having a degree of vacuum of 1 Pa, and a carbon hydride protecting film 4a was formed by a plasma CVD method with a bias application of −300 V. At this time, a temperature of a substrate in the film formation was set to be 260° C.

Except for the above aspects, the magnetic disk is the same as that obtained by the same manufacturing method as that in the example 1.

The evaluation and analysis was carried out over the obtained magnetic disk according to the comparative example in the same manner as in the example 1. The result is shown in the Table 1.

An atomic weight ratio (N/C) of nitrogen/carbon was 0.154. As the reason, it can be supposed that the carbon hydride protecting film 4a was formed at a high temperature and the carbon hydride protecting film 4a was thus graphitized so that a smaller hardness than that in the example 1 was obtained.

Therefore, a hardness of the whole protecting layer 4 was not sufficient and both a sliding property of a pin-on-disk and an LUL test failed.

### Example 6

Next, a magnetic disk according to an example 6 was manufactured.

In the magnetic disk according to the example 1, when the protecting layer 4 was formed, an ethylene gas was introduced in an amount of 250 sccm and a plasma ignition was carried out using an igniter at a pressure having a degree of vacuum of 1 Pa, and a carbon hydride protecting film 4a was formed by a plasma CVD method with a bias application of −300 V. At this time, in a cooling chamber immediately before the film formation, an He gas having a great specific heat and a high cooling efficiency was introduced to forcibly cool a substrate and to set a temperature of the substrate in the film formation to be 25° C.

Except for the above aspects, the magnetic disk is the same as that obtained by the same manufacturing method as that in the example 1.

The evaluation and analysis was carried out over the obtained magnetic disk according to the example in the same manner as in the example 1. The result is shown in the Table 1.

An atomic weight ratio (N/C) of nitrogen/carbon was 0.135.

It is apparent that a sliding property of a pin-on-disk can be enhanced more greatly and a denser protecting layer 4 is formed as compared with the example 1.

### Comparative Example 6

Next, a magnetic disk according to a comparative example 6 was manufactured.

In the magnetic disk according to the example 1, when the protecting layer 4 was formed, an ethylene gas was introduced in an amount of 250 sccm and a plasma ignition was carried out using an igniter at a pressure having a degree of vacuum of 1 Pa, and a carbon hydride protecting film 4a was formed by a plasma CVD method with a bias application of −40 V. At this time, a temperature of a substrate in the film formation was set to 250° C.

Except for the above aspects, the magnetic disk is the same as that obtained by the same manufacturing method as that in the example 1.

The evaluation and analysis was carried out over the obtained magnetic disk according to the comparative example in the same manner as in the example 1. The result is shown in the Table 1.

An atomic weight ratio (N/C) of nitrogen/carbon was 0.162. The reason can be supposed that an applied bias voltage was excessively low.

Therefore, a hardness of the whole protecting layer 4 was not sufficient and both a sliding property of a pin-on-disk and an LUL test failed.

### Comparative Example 7

Next, a magnetic disk according to a comparative example 7 was manufactured.

In the magnetic disk according to the example 1, when the protecting layer 4 was formed, an ethylene gas was introduced in an amount of 250 sccm and a plasma ignition was carried out using an igniter at a pressure having a degree of vacuum of 1 Pa, and a carbon hydride protecting film 4a was formed by a plasma CVD method with a bias application of −310 V. At this time, a temperature of a substrate in the film formation was set to be 250° C.

Except for the above aspects, the magnetic disk is the same as that obtained by the same manufacturing method as that in the example 1.

The evaluation and analysis was carried out over the obtained magnetic according to the comparative example in the same manner as in the example 1. The result is shown in the Table 1.

At this time, an excessive bias was applied. As a result, an abnormal discharge was generated so that the substrate was broken.

### Comparative Example 8

Next, a magnetic disk according to a comparative example 8 was manufactured.

In the magnetic disk according to the example 1, when the protecting layer 4 was formed, an ethylene gas was introduced in an amount of 250 sccm and a plasma ignition was tried without using an igniter at a pressure having a degree of vacuum of 1 Pa. However, a discharge was not generated. As a result, the carbon hydride protecting film 4a could not be formed.

### Example 7

Next, a magnetic disk according to an example 7 was manufactured.

In the magnetic disk according to the example 1, when the protecting layer 4 was formed, an ethylene gas was introduced in an amount of 250 sccm and a plasma ignition was carried out using an igniter at a pressure having a degree of vacuum of 1 Pa, and a carbon hydride protecting film 4a was formed by a plasma CVD method with a bias application of −300 V. Then, a step of forming a surface layer portion 4b was not carried out.

The step of forming the protecting layer 4 is the same as that in the example 1 except that the step of forming the surface layer portion 4b was not carried out.

Except for the above aspects, the magnetic disk is the same as that obtained by the same manufacturing method as that in the example 1. The evaluation and analysis was carried out over the obtained magnetic disk according to the example in the same manner as in the example 1. The result is shown in the Table 1.

Since the surface layer portion 4b was not provided, a sliding property of a pin-on-disk was very excellent.

In the example, an advantage of increasing a hardness of the carbon hydride protecting film 4a is confirmed.

For this reason, an LUL test was not carried out.

While the present invention has been described above with reference to the embodiment, the technical scope of the present invention is not limited to the scope described in the embodiment.

It is apparent to a person skilled in the art that various changes or improvements can be made to the embodiment.

It is apparent from the description of claims that a configuration subjected to the changes or improvements can also be included in the technical scope of the present invention.

### INDUSTRIAL APPLICABILITY

The present invention is applicable to a magnetic disk, for example.

1. A method of manufacturing a magnetic disk comprising at least a substrate, a magnetic layer formed on the substrate in order to carry out magnetic recording, and a protecting layer formed on the magnetic layer in order to protect the magnetic layer, the protecting layer including a carbon hydride protecting film substantially formed of carbon and hydrogen on a side of the magnetic layer, the method comprising:
(a) forming the carbon hydride protecting film at an atmosphere having a degree of vacuum ranging from 0.1 Pa to 2 Pa while carrying out a plasma ignition using an igniter for maintaining a stable plasma discharge.

2. The method according to claim 1, wherein the magnetic disk further comprises a lubricating layer formed on the protecting layer, and
wherein the protecting layer includes a surface layer portion provided between the carbon hydride protecting film and the lubricating layer, the surface layer portion containing carbon and nitrogen and having a higher adhesion to the lubricating layer than the carbon hydride protecting film,
the method further comprising:
(b) forming the surface layer portion at an atmosphere having a degree of vacuum ranging from 2 Pa to 6 Pa.

3. The method according to claim 1, wherein step (a) comprises: forming the carbon hydride protecting film by a plasma CVD method in which only a straight-chain saturated hydrocarbon gas is substantially used as a reactant gas without using carrier gas.

4. The method according to claim 1, wherein an atomic weight ratio (N/C) of nitrogen and carbon is in a range of 0.05 to 0.15 in an uppermost surface of the protecting layer.

5. The method according to claim 1, wherein the magnetic disk is used for an HDD having an LUL system.

6. A magnetic disk comprising:
a substrate;
a magnetic layer formed on the substrate in order to carry out magnetic recording; and
a protecting layer formed on the magnetic layer in order to protect the magnetic layer, the protecting layer including a carbon hydride protecting film substantially formed of carbon and hydrogen on a side of the magnetic layer,
wherein an atomic weight ratio (N/C) of nitrogen and carbon is in a range of 0.05 to 0.15 in an uppermost surface of the protecting layer.
